(19) United States
(12) Patent Application Publication
(10) Pub. No.: US 2025/0302081 A1
(43) Pub. Date: Oct. 2, 2025

(54) Pre-Workout Supplement

(71) Applicant: Hayden Greene, Costa Mesa, CA (US)

(72) Inventor: Hayden Greene, Costa Mesa, CA (US)

(21) Appl. No.: 19/088,179

(22) Filed: Mar. 24, 2025

Related U.S. Application Data
(60) Provisional application No. 63/572,939, filed on Apr. 2, 2024.

(51) Int. Cl. A23L 33/175; A23L 33/125; A23L 33/15

(52) U.S. Cl. CPC A23L 33/175; A23L 33/125; A23L 33/15

(57) ABSTRACT

A pre-workout lollipop composition for enhancing workout performance and supporting muscle function and recovery is disclosed. The lollipop is a unique blend of essential pre-workout ingredients, comprising 1.5 weight percentage caffeine anhydrous, 10 weight percentage beta alanine, 0.05 weight percentage vitamins B6 and B12, 50 weight percentage mixture of corn syrup and brown rice syrup, 15 weight percentage L-citrulline, 1.5 weight percentage electrolytes, and 22 weight percentage natural flavors and sweeteners. The lollipop is consumed about 30 minutes before physical activity, offering a convenient and effective supplement solution. In one embodiment, the ingredients are combined into a syrup base, mixed uniformly, and then poured into molds to form the lollipops. This innovative delivery system provides rapid absorption of ingredients in the mouth and stomach, enhancing alertness, endurance, and overall workout performance.

### CROSS-REFERENCE TO RELATED APPLICATION

The present application claims priority to, and the benefit of, U.S. Provisional Application No. 63/572,939, which was filed on Apr. 2, 2024 and is incorporated herein by reference in its entirety.

### FIELD OF THE INVENTION

The present invention generally relates to the field of pre-workout or nutritional supplements. More specifically, the present invention relates to a novel pre-workout lollipop composition for enhancing workout performance and supporting muscle recovery. The lollipop is a unique blend of essential pre-workout ingredients, comprising caffeine anhydrous, beta alanine, vitamin supplements with optional ingredients such as a mixture of corn syrup and brown rice syrup, L-citrulline, L-taurine, creatine, branch chain amino acids, nitric oxide and arginine, beet root extract, and electrolytes for maintaining hydration. The lollipop is consumed for effective absorption in the mouth and stomach, providing rapid onset of effects and a convenient, mess-free pre-workout solution. It is to be appreciated that the pre-workout or nutritional supplement can be in the form of a gummy or hard shell composition. Accordingly, the present disclosure makes specific reference thereto. Nonetheless, it is to be appreciated that aspects of the present invention are also equally applicable to other like applications, devices, and methods of manufacture.

### BACKGROUND

By way of background, pre-workouts are supplements designed to boost energy, focus, and athletic performance before exercise. Traditional pre-workout products come in the form of powders, beverages, and shakes. However, they often present several inconveniences and drawbacks for users, particularly when users are on the go or traveling to and from a gym. Preparing traditional pre-workout products can be frustrating and time-consuming. For example, pre-workout powders require mixing with water or other liquids, which can lead to messes and the need for cleanup afterward. Shaker cups containing pre-workout drinks can leak or spill and lead to further inconvenience and mess. Additionally, pre-packaged pre-workout beverages in cans or bottles can become agitated during transport, potentially causing them to spray upon opening.

Commonly, consuming large quantities of liquid before a workout can be uncomfortable for individuals. The exercise followed by taking pre-workout can cause digestive discomfort, leading to bloating, cramps, or an unsettled stomach. As a result, people desire a more convenient, mess-free, and effective delivery system for pre-workout or nutritional supplements.

Therefore, there exists a long-felt need in the art for a novel pre-workout or nutritional supplement delivery system designed to enhance workout performance and muscle recovery. Additionally, there is a long-felt need in the art for a pre-workout composition that is convenient and mess-free, avoiding the common issues associated with powders and liquid supplements. Moreover, there is a long-felt need in the art for a pre-workout product that eliminates the need for mixing and cleanup, making it ideal for use on the go. Further, there is a long-felt need in the art for a pre-workout or nutritional supplement that provides rapid absorption of nutrients without causing digestive discomfort during exercise. Furthermore, there is a long-felt need in the art for a pre-workout or nutritional supplement that combines essential ingredients into a single, portable, and tasty format. Also, there is a long-felt need in the art for a pre-workout delivery system that is user-friendly and can be easily consumed without preparation (i.e., lollipop, gummy, hard shell, et. al.). Finally, there is a long-felt need in the art for a pre-workout or nutritional supplement that offers a practical and effective alternative to traditional pre-workout powders, beverages, and pills.

The subject matter disclosed and claimed herein, in one embodiment thereof, comprises a pre-workout or nutritional supplement delivery lollipop. The lollipop is configured to be consumed by a user, the lollipop including a combination of ingredients selected from the group consisting of caffeine anhydrous, beta alanine, vitamin supplements, brown rice syrup, L-taurine, creatine, branch chain amino acids, arginine, beet root extract, and electrolytes, wherein the ingredients are absorbed in the mouth and stomach, providing a rapid onset of their effects. The lollipop, gummy, hard shell supplement, et. al., is configured to be consumed about 10 to 40 minutes before physical activity.

In this manner, the pre-workout lollipop (i.e., gummy, hard shell, et. al.) composition of the present invention accomplishes all of the forgoing objectives and provides users with a convenient and effective pre-workout or nutritional supplement delivery system. The lollipop is particularly beneficial for individuals seeking to enhance their workout performance and muscle recovery without the hassle of traditional pre-workout products. The lollipop is easy to use and can be consumed directly without the need for mixing or preparation. The composition contains essential pre-workout ingredients, each selected for their unique benefits to physical performance and endurance. The lollipop provides rapid absorption of nutrients while minimizing the risk of digestive discomfort. Additionally, the lollipop (i.e., gummy, hard shell, et. al.) is portable and mess-free, making it ideal for use on the go.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pre-workout lollipop (i.e., gummy, hard shell, et. al.) composition. The pre-workout lollipop, or sans stick hard shell/gummy, composition consists of caffeine anhydrous for enhancing alertness, focus, and energy levels, beta alanine for delaying muscle fatigue and enhancing endurance, vitamin supplements for supporting energy metabolism and muscle repair, a mixture of corn syrup and brown rice syrup for providing a quick source of carbohydrates and energy, L-citrulline for enhancing blood flow and reducing muscle soreness, L-taurine for supporting neurological development and regulating water and mineral levels, creatine for increasing strength and muscle mass, branch chain amino acids (BCAAs) for reducing muscle soreness and enhancing muscle growth, nitric oxide for improving exercise efficiency, arginine for supporting vasodilation, beet root extract for improving oxygen utilization, and electrolytes for maintaining hydration and muscle function. The pre-workout lollipop is consumed by a user for rapid absorption of these ingredients to enhance workout performance and support muscle function and recovery.

In a further embodiment, a pre-workout lollipop (i.e., gummy, hard shell, et. al.) composition for enhancing workout performance and supporting muscle function is disclosed. The pre-workout lollipop composition includes ingredients and consists of, in one embodiment, (i) 1.5 weight percentage caffeine anhydrous, (ii) 10 weight percentage beta alanine, (iii) 0.05 weight percentage vitamins B6 and B12, (iv) 50 weight percentage mixture of corn syrup and brown rice syrup, (v) 15 weight percentage L-citrulline, (vi) 1.5 weight percentage electrolytes, and (vii) 22 weight percentage natural flavors and sweeteners.

In yet another embodiment, a pre-workout lollipop composition for supporting muscle function and recovery is disclosed. The pre-workout lollipop composition, in another embodiment, includes ingredients and consists of (i) 1 weight percentage caffeine anhydrous, (ii) 5 weight percentage beta alanine, (iii) 0.03 weight percentage vitamins B6 and B12, (iv) 20 weight percentage brown rice syrup, (v) 10 weight percentage L-taurine, (vi) 15 weight percentage creatine, (vii) 25 weight percentage branch chain amino acids, (viii) 5 weight percentage arginine, (ix) 2 weight percentage beet root extract, (x) 1 weight percentage electrolytes, and (xi) 16 weight percentage natural flavors and sweeteners.

In yet another embodiment, a method of making a pre-workout lollipop composition adapted for enhancing workout performance of a user is disclosed. The method comprises the steps of forming a syrup base using corn syrup and brown rice syrup combined in a heated vessel until fully dissolved and uniform, adding active ingredients including L-citrulline, L-taurine, caffeine anhydrous, and beta alanine to the syrup base for uniform mixing and even distribution, adding other ingredients including beet root extract and branch chain amino acids for enhancing functionality of the lollipop, adding sweeteners and flavoring agents to the mixture to enhance taste and mask any potential bitterness or sourness from active ingredients, and pouring the mixture into lollipop molds, inserting a stick into the mold, and allowing the mixture to cool and solidify to form lollipops. The ingredients are combined into a single, convenient, and tasty format.

In another aspect, a pre-workout or nutritional supplement delivery system is disclosed. The system comprises a lollipop configured to be consumed by a user, the lollipop including a combination of ingredients selected from the group consisting of caffeine anhydrous, beta alanine, vitamin supplements, brown rice syrup, L-taurine, creatine, branch chain amino acids, arginine, beet root extract, and electrolytes, wherein the ingredients are absorbed in the mouth and stomach, providing a rapid onset of their effects. The lollipop is configured to be consumed about 10 to 40 minutes before physical activity.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram depicting the ingredients of the pre-workout lollipop of the present invention, in accordance with one embodiment of the present invention;

FIG. 2 illustrates the steps performed in making the pre-workout or nutritional supplement delivery lollipop 100 of the present invention in accordance with one embodiment of the present invention; and

FIG. 3 illustrates a perspective view of pre-workout or nutritional supplement delivery lollipop of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a novel pre-workout or nutritional supplement delivery system designed to enhance workout performance and muscle recovery. Additionally, there is a long-felt need in the art for a pre-workout composition that is convenient and mess-free, avoiding the common issues associated with powders and liquid supplements. Moreover, there is a long-felt need in the art for a pre-workout product that eliminates the need for mixing and cleanup, making it ideal for use on the go. Further, there is a long-felt need in the art for a pre-workout or nutritional supplement that provides rapid absorption of nutrients without causing digestive discomfort during exercise. Furthermore, there is a long-felt need in the art for a pre-workout or nutritional supplement that combines essential ingredients into a single, portable, and tasty format. Also, there is a long-felt need in the art for a pre-workout delivery system that is user-friendly and can be easily consumed without preparation. Finally, there is a long-felt need in the art for a pre-workout or nutritional supplement that offers a practical and effective alternative to traditional pre-workout powders, beverages, and pills.

The present invention, in one exemplary embodiment, is a pre-workout lollipop composition for supporting muscle function and recovery. The pre-workout lollipop composition includes ingredients and consists of caffeine anhydrous, beta alanine, vitamins B6 and B12, brown rice syrup, L-taurine, creatine, branch chain amino acids, arginine, beet root extract, electrolytes, and natural flavors and sweeteners.

The terms “about” and “approximately” as used herein, indicate that the precision of the nominal value presented is plus or minus 25%.

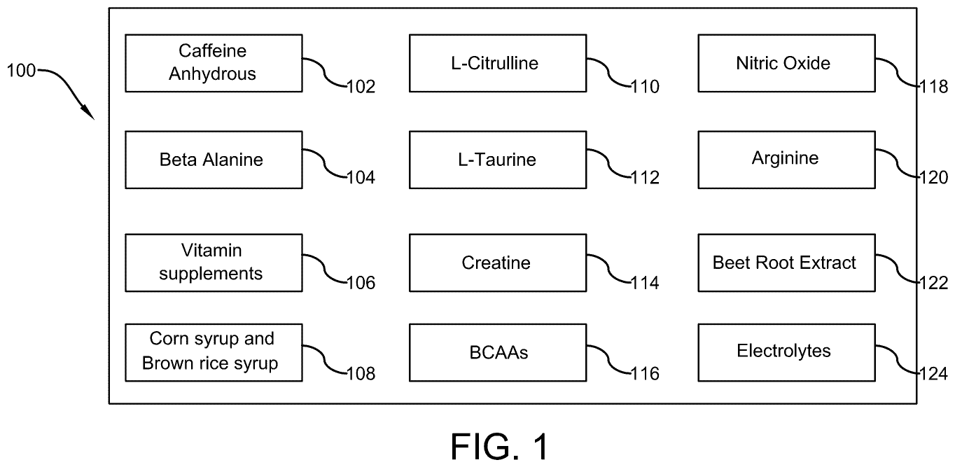

Referring initially to the drawings, FIG. 1 illustrates a block diagram depicting the ingredients of the pre-workout lollipop of the present invention, in accordance with one embodiment of the present invention. The pre-workout lollipop 100 includes Caffeine Anhydrous 102, Beta Alanine 104, Vitamin supplements 106, a mixture of Corn syrup and Brown rice syrup 108, L-Citrulline 110, L-Taurine 112, Creatine 114, Branch Chain Amino Acids (BCAAs) 116, Nitric Oxide 118, Arginine 120, Beet Root Extract 122, and Electrolytes 124. The pre-workout lollipop 100 serves as a convenient delivery system for pre-workout or nutritional supplements. When the lollipop 100 is consumed, the said ingredients are absorbed in the mouth and stomach, providing rapid onset of their effects.

The pre-workout lollipop 100 is configured to be consumed like a conventional lollipop and is ideal for pre-workout intake without the need for mixing powders or taking multiple pills. The lollipop 100 integrates essential pre-workout ingredients into a single, convenient, and tasty format, enhancing workout performance and supporting muscle function and recovery.

Caffeine Anhydrous 102 (1,3,7-Trimethylxanthine) is a potent central nervous system stimulant that enhances alertness, focus, and energy levels by blocking adenosine receptors in the brain. Caffeine Anhydrous 102 also improves mental clarity and physical performance, thereby reducing perception of effort during workouts.

Beta Alanine 104 (3-Aminopropanoic acid) is an amino acid that increases carnosine levels in muscles, which helps buffer acid in muscles during intense exercise. Beta Alanine 104 delays muscle fatigue, enhances endurance, and improves overall workout performance. Specifically, Beta alanine 104 serves as a precursor to carnosine, which buffers lactic acid in muscles, delaying fatigue and enhancing endurance.

Vitamin supplements 106 includes Vitamins B6 and B12 which are important for energy metabolism and the formation of red blood cells. Vitamin supplements 106 support energy production, reduces fatigue, and improves muscle repair and growth.

Mixture of Corn syrup and Brown rice syrup 108 provides a quick source of carbohydrates and energy. The mixture 108 provides instant energy boost to fuel workouts and helps maintain blood sugar levels.

L-Citrulline 110 (2-Amino-5-(carbamoylamino) pentanoic acid) is an amino acid that increases nitric oxide production in the human body. L-Citrulline 110 enhances blood flow, reduces muscle soreness, and improves exercise performance. Specifically, L-Citrulline 110 is converted into L-arginine in the kidneys, which then increases nitric oxide production. Nitric oxide relaxes blood vessels, improving blood flow and oxygen delivery to muscles.

L-Taurine 112 (2-Aminoethanesulfonic acid) is an amino acid that supports neurological development and regulates water and mineral levels in the blood. L-Taurine 112 improves exercise capacity, reduces muscle damage and fatigue. Creatine 114 helps produce adenosine triphosphate (ATP) and increases strength, muscle mass, and exercise performance, particularly in high-intensity activities.

Branch Chain Amino Acids (BCAAs) 116 comprise leucine, isoleucine, and valine, which are essential for muscle protein synthesis. BCAAs reduce muscle soreness, decrease exercise fatigue, and enhance muscle growth. Nitric Oxide 118 widens blood vessels, increasing blood flow and oxygen delivery to muscles. During workouts, Nitric Oxide 118 enhances endurance, reduces muscle soreness, and improves exercise efficiency.

Arginine 120 is an amino acid that converts to nitric oxide in the body. Arginine 120 supports vasodilation, improves blood flow, and enhances exercise performance. Beet Root Extract 122 contains nitrates which convert to nitric oxide in the body and improves oxygen utilization, enhances endurance, and reduces fatigue. Electrolytes 124 are included which contain minerals like sodium, potassium, and magnesium that are crucial for maintaining hydration and muscle function. Electrolytes 124 prevent dehydration, reduce muscle cramps, and maintain optimal muscle function during exercise.

In the preferred embodiment, the ingredients Caffeine Anhydrous 102, Beta Alanine 104, and Vitamin supplements 106 are essential and the ingredients can be optionally added to the lollipop 100. Further, the lollipop 100 can be consumed about 30 minutes before physical activity, offering a user-friendly and effective supplement solution.

Table 1 below shows approximate concentrations of various ingredients in the pre-workout or nutritional supplements delivery lollipop 100.

TABLE 1

| | Composition in percentage by |
|---|---|
| Ingredients | weight (% w/w) |
| Caffeine Anhydrous | 0.5-5.0 |
| Beta Alanine | 2-20 |
| Vitamin B6, B12 | 0.01-0.10 |
| Mixture of Corn Syrup and Brown Rice | 30-70 |
| Syrup | |
| L-Citrulline | 5-30 |
| Electrolytes | 0.5-5.0 |
| Natural flavors and sweeteners | 10-40 |

Table 2 below shows approximate concentrations of various ingredients in another embodiment of the pre-workout or nutritional supplements delivery lollipop 100.

TABLE 2

| | Composition in percentage by |
|---|---|
| Ingredients | weight (% w/w) |
| Caffeine Anhydrous | 0.05-2.0 |
| Beta Alanine | 2-10 |
| Vitamin B6, B12 | 0.01-0.06 |
| Brown Rice Syrup | 10-30 |
| L-Taurine | 2-20 |
| Creatine | 5-30 |
| Branch Chain Amino Acids | 15-35 |
| Arginine | 2-10 |
| Beet Root Extract | 0.10-4.0 |
| Electrolytes | 0.02-2.0 |
| Natural flavors and sweeteners | 5.0-30.0 |
| Nitric Oxide | 0.05-0.2 |

The caffeine 102 can have a weight up to about 600 mg in a single dose of lollipop and Creatine 114 can have a weight up to about 12 grams. Arginine 120 can have a weight up to about 4 gram in the lollipop. It will be apparent that any combination of ingredients not limited to what is disclosed in the present disclosure are contemplated by the present disclosure.

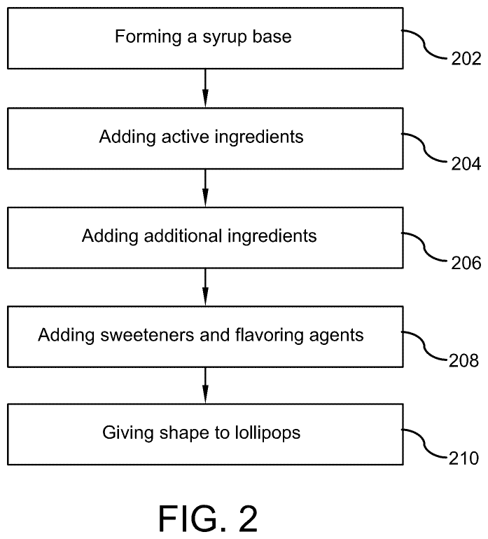

FIG. 2 illustrates the steps performed in making the pre-workout or nutritional supplement delivery lollipop 100 of the present invention in accordance with one embodiment of the present invention. The pre-workout lollipop 100 can be made automatically or manually as per preferences of users. Initially, a syrup base is formed using corn syrup and brown rice syrup which are combined in a heated vessel until fully dissolved and uniform (Step 202). Then, active ingredients like L-Citrulline, L-Taurine, caffeine anhydrous, and beta alanine are added to the syrup base for uniform mixing and even distribution (Step 204). Thereafter, other ingredients like Beet root extract, BCAAs are added for enhancing functionality of the lollipop (Step 206). Then, sweeteners and flavoring agents are added to the mixture to enhance taste and mask any potential bitterness or sourness from active ingredients (Step 208). Finally, the mixture is poured into lollipop molds, a stick is inserted into the mold and is allowed to cool and solidify to form lollipops (Step 210).

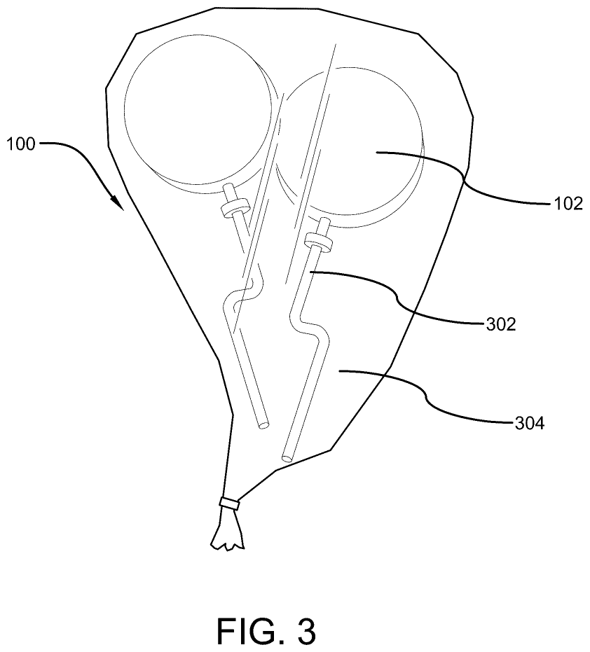

FIG. 3 illustrates a perspective view of pre-workout or nutritional supplement delivery lollipop of the present invention in accordance with the disclosed structure. As illustrated, the lollipop 100 includes the solidified pre-workout mixture composition 102 which can be in any geometric shape and preferably circular. The lollipop can come in different flavors and colors to meet requirements of different users. A stick 302 is a part of the lollipop 100 and is used for easy handling while consuming the lollipop 100. The stick 302 is preferably made of a biodegradable and environmentally friendly material such as paper, paperboard, or wood. The lollipop 100 can be packaged individually on in a pack of multiple lollipops as per user preferences. The packaging 304 is airtight and made of food-friendly material to maintain freshness and stability of the lollipops.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pre-workout lollipop”, “pre-workout or nutritional supplements delivery lollipop”, “lollipop”, and “pre-workout or nutritional supplement delivery lollipop composition” are interchangeable and refer to the pre-workout or nutritional supplement delivery lollipop composition 100 of the present invention.

Notwithstanding the forgoing, the pre-workout or nutritional supplement delivery lollipop composition 100 of the present invention can be of any suitable size and configuration as is known in the art without affecting the overall concept of the invention, provided that it accomplishes the above stated objectives. One of ordinary skill in the art will appreciate the pre-workout or nutritional supplement delivery lollipop composition 100 as shown in the FIGS. is for illustrative purposes only, and that many other configurations of the pre-workout or nutritional supplement delivery lollipop composition 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pre-workout supplement comprising:
a pre-workout supplement having a composition selected from one or more of the group consisting of: a caffeine anhydrous, a beta alanine, vitamins B6 and B12, a mixture of corn syrup and brown rice syrup, an L-citrulline, an electrolyte, and natural flavors and sweeteners.

2. The pre-workout supplement of claim 1, wherein said caffeine anhydrous having a weight percentage of said composition from 0.5% to 5.0%.

3. The pre-workout supplement of claim 2, wherein said beta alanine having a weight percentage of said composition from 2% to 20%.

4. The pre-workout supplement of claim 3, wherein a combination of said vitamins B6 and B12 having a weight percentage of said composition from 0.01% to 0.10%.

5. The pre-workout supplement of claim 4, wherein a mixture of said corn syrup and said brown rice syrup having a weight percentage of said composition from 30% to 70%.

6. The pre-workout supplement of claim 5, wherein said L-Citrulline having a weight percentage of said composition from 5% to 30%.

7. The pre-workout supplement of claim 6, wherein said electrolytes having a weight percentage of said composition from 0.5% to 5%.

8. The pre-workout supplement of claim 7, wherein a mixture of said natural flavors and sweeteners having a weight percentage of said composition from 10% to 40%.

9. The pre-workout supplement of claim 8, wherein said pre-workout or nutritional supplement having a form selected from the group consisting of a lollipop, a hard shell, and a gummy.

10. A nutritional supplement comprising:
a nutritional supplement having a composition selected from one or more of the group consisting of: a caffeine anhydrous, a beta alanine, vitamins B6 and B12, a brown rice syrup, a L-taurine, a creatine, branch chain amino acids, an arginine, a beet root extract, an electrolyte, natural flavors and sweeteners, and nitric oxide.

11. The nutritional supplement of claim 10, wherein said caffeine anhydrous having a weight percentage of said composition from 0.05% to 2.0%.

12. The nutritional supplement of claim 11, wherein said beta alanine having a weight percentage of said composition from 2% to 10%.

13. The nutritional supplement of claim 12, wherein a combination of said vitamins B6 and B12 having a weight percentage of said composition from 0.01% to 0.06%.

14. The nutritional supplement of claim 13, wherein said brown rice syrup having a weight percentage of said composition from 10% to 30%.

15. The nutritional supplement of claim 14, wherein said L-taurine having a weight percentage of said composition from 2% to 20%.

16. The nutritional supplement of claim 15, wherein said creatine having a weight percentage of said composition from 5% to 30%.

17. The nutritional supplement of claim 16, wherein said branch chain amino acids having a weight percentage of said composition from 15% to 35%.

18. The nutritional supplement of claim 17, wherein said arginine having a weight percentage of said composition from 2% to 10%.

19. The nutritional supplement of claim 18, wherein said beet root extract having a weight percentage of said composition from 0.10% to 4%;
wherein said electrolytes having a weight percentage of said composition from 0.02% to 2%;
wherein said natural flavors and sweeteners having a weight percentage of said composition from 5.0% to 30.0%; and
further wherein said nitric oxide having a weight percentage of said composition from 0.05% to 0.20%.

20. A nutritional supplement comprising:
a nutritional supplement composition selected from one or more of the group consisting of:
a caffeine anhydrous;
a beta alanine;
vitamin B6;
vitamin B12;
a brown rice syrup;
a L-taurine;
a creatine;
branch chain amino acids;
an arginine;
a beet root extract;
an electrolyte;
natural flavors and sweeteners; and
a nitric oxide;
wherein said caffeine anhydrous having a weight percentage of said composition from 0.05% to 2.0%;
wherein said beta alanine having a weight percentage of said composition from 2% to 10%;
wherein a combination of said vitamins B6 and B12 having a weight percentage of said composition from 0.01% to 0.06%;
wherein said brown rice syrup having a weight percentage of said composition from 10% to 30%;
wherein said L-taurine having a weight percentage of said composition from 2% to 20%;
wherein said creatine having a weight percentage of said composition from 5% to 30%;
wherein said branch chain amino acids having a weight percentage of said composition from 15% to 35%;
wherein said arginine having a weight percentage of said composition from 2% to 10%;
wherein said beet root extract having a weight percentage of said composition from 0.10% to 4%;
wherein said electrolytes having a weight percentage of said composition from 0.02% to 2%;
wherein said natural flavors and sweeteners having a weight percentage of said composition from 5.0% to 30.0%; and
further wherein said nitric oxide having a weight percentage of said composition from 0.05% to 0.20%.
